(19) United States
(12) Patent Application Publication
(10) Pub. No.: US 2026/0240199 A1
(43) Pub. Date: Aug. 20, 2026

(54) PROCESS FOR PRODUCING A FIBROUS PROTEINACEOUS EXTRUDATE

(71) Applicant: CONOPCO, INC., D/B/A UNILEVER, Hoboken, NJ (US)

(72) Inventors: Grzegorz BEDNARSKI, Wageningen (NL); Johannes Petrus Martinus VAN DUYNHOVEN, Wageningen (NL)

(73) Assignee: CONOPCO, INC., D/B/A UNILEVER, Hoboken, NJ (US)

(21) Appl. No.: 19/134,783

(22) PCT Filed: Dec. 21, 2023
(86) PCT No.: PCT/EP2023/087210

§ 371 Date: Jun. 2, 2025

(30) Foreign Application Priority Data
Dec. 23, 2022 (EP) 22216549.0

(51) Int. Cl. A23J 3/26

(52) U.S. Cl. CPC A23J 3/26

(57) ABSTRACT

The invention relates to a process for producing a fibrous proteinaceous extrudate, said process comprising the steps of:
a) providing an aqueous proteinaceous slurry;
b) processing said aqueous proteinaceous slurry in an extruder, said processing comprising the following steps:
   a heating step to produce a hot slurry;
   a kneading step comprising transporting the hot slurry through a sequence of one or more kneading barrels having a barrel temperature of 151-200° C., the hot slurry being kneaded in the one or more kneading barrels to produce a pre-texturized proteinaceous mass; and
   a pre-cooling step to produce a texturized proteinaceous mass;
c) passing the texturized proteinaceous mass through a breaker plate from the extruder into a cooling die to produce a structured proteinaceous mass; and
d) expelling the structured proteinaceous mass from the cooling die to produce a fibrous proteinaceous extrudate.

The process of the present invention enables the preparation of a fibrous proteinaceous extrudate that has excellent texture, similar to chicken meat.

### TECHNICAL FIELD OF THE INVENTION

The present invention relates to a high moisture extrusion process for producing a fibrous proteinaceous product. The process is carried out by processing a proteinaceous slurry in an extruder, passing the processed slurry via breaker plate from the extruder into a cooling die, and expelling the processed mass from the cooling die. In the extruder, the slurry is heated, and successively subjected to a kneading step and a pre-cooling step. The extrudate obtained by the present process can suitably be used in meat analogues as it has an appearance and texture that are very similar to that of e.g. chicken meat.

The invention also relates to fibrous protein extrudates that can be obtained the aforementioned process.

### BACKGROUND OF THE INVENTION

Consumption of resource-intensive foods, such as animal-based products, is associated with high greenhouse gas emissions, placing a heavy burden on the food system. Transition to a more sustainable diet with higher intake of plant-based foods has been identified as a key factor in improving health and reducing environmental pressure on the current food system.

There is a fast-growing market for meat analogues. Meat analogues can be produced from plant protein raw materials using low- or high moisture extrusion cooking. Products prepared by the low-moisture extrusion technique have a porous structure and the texture does not resemble animal flesh. In contrast, high-moisture extrusion (HME) can create products with a fibrous meat-like structure.

During the HME process, plant proteins are unfolded, aggregated, crosslinked and realigned with heat, pressure and shear in an extruder. In a cooling die, the proteins are aligned, leading to the formation of a fibrous meat-like structure. The covalent disulphide bonds and, to a smaller extent, the non-covalent bonds between proteins are believed to be essential in forming a fibrous structure. The fibrous structure formation also depends on several other factors, among which the amount and type of proteins in the raw material are important.

### ADDITIONAL INFORMATION

US 2014/0127363 describes a process for the preparation of a structured vegetable protein extrudate having a fibrous meat-like structure, comprising the steps of
(a) providing an aqueous protein composition comprising vegetable protein, wherein the protein content based on dry matter is at least 15% by weight and below 85% by weight;
(b) subjecting the aqueous protein composition to one or more kneading steps so as to form a dough;
(c) subjecting the dough to heating to above the denaturation temperature of the protein;
(d) subjecting the dough to shear forces and pressure in an extruder, so as to form a fibrous protein composition;
(e) allowing the fibrous protein composition to exit the extruder through an extruder die;
   wherein the water content of the aqueous protein composition is at least 50% by weight, and wherein fibrous protein composition is subjected to limited cooling so as to exit the extruder at a temperature, of the composition, of at least the boiling temperature of water in said first outside environment.

Yao et al. (A New Method for Characterizing Fiber Formation in Meat Analogs during High-moisture Extrusion, Journal of Food Science, Vol. 69, Nr. 7, 2004, 303-307) describe a process in which soy protein, wheat gluten, and unmodified wheat starch were mixed and extruded at high moisture conditions to form meat analogs with 60% to 72% moisture.

Snel et al. (Novel rotating die coupled to a twin-screw extruder as a new route to produce meat analogues with soy, pea and gluten), Innovative Food Science and Emerging Technologies 81 (2022) 103152) describe a study in which a combination of high moisture extrusion cooking (HMEC) with well-defined shear during cooling was applied via a specially designed cooling die attached to the extruder.

Although the plant-based meat analogues that are currently commercially available have gained wide consumer acceptance, the texture of these products is generally deemed to be inferior to that of meat products.

### SUMMARY OF THE INVENTION

The inventors have developed a process that enables the preparation of a fibrous proteinaceous extrudate that has excellent texture and appearance, similar to chicken meat. The process of the present invention comprises high moisture extrusion in an extruder that comprises at least three separate temperature controlled zones, including a heating zone, a kneading zone and a pre-cooling zone, followed by passage through a breaker plate into a cooling die where the extrudate is further cooled before being expelled. The fibrous proteinaceous extrudate that is obtained by the present process has excellent textural properties, notably an optimum balance between “elasticity” and “toughness”.

Accordingly, a first aspect of the invention relates to a process for producing a fibrous proteinaceous extrudate, said process comprising the steps of:
a) providing an aqueous proteinaceous slurry said slurry comprising at least 52 wt % of water;
b) processing said aqueous proteinaceous slurry in an extruder, said processing comprising the following steps:
   a heating step comprising transporting the aqueous proteinaceous slurry through a sequence of one or more extrusion barrels having a barrel temperature of at least 90° C., to produce a hot slurry;
   a kneading step comprising transporting the hot slurry through a sequence of one or more kneading barrels having a barrel temperature of 151-200° C., the hot slurry being kneaded in the one or more kneading barrels to produce a pre-texturized proteinaceous mass;
   a pre-cooling step comprising transporting the pre-texturized proteinaceous mass through a sequence of one or more extrusion barrels having a barrel temperature that is at least 15° C. lower than the barrel temperature of the one or more kneading barrels, to produce a texturized proteinaceous mass;
c) passing the texturized proteinaceous mass through a breaker plate from the extruder into a cooling die in which the texturized proteinaceous mass is given a residence time of at least 10 seconds to produce a structured proteinaceous mass; and
d) expelling the structured proteinaceous mass from the cooling die at a flow rate of 30 to 1000 g/h/mm² to produce a fibrous proteinaceous extrudate.

A second aspect of the invention relates to the fibrous extrudate that can be obtained by the process according to the invention.

A third aspect of the invention relates to a process of preparing marinated proteinaceous pieces from the aforementioned fibrous proteinaceous extrudate by dividing the extrudate into proteinaceous pieces, and marinating these pieces with a marination liquid comprising one or taste contributing ingredients selected from spices, herbs, flavouring and combinations thereof.

A fourth aspect of the invention relates to marinated proteinaceous pieces that can be obtained by the aforementioned marination process.

### DETAILED DESCRIPTION OF THE INVENTION

Any feature presented herein as belonging to one particular aspect of the present invention may also be utilised in connection with other aspects of the invention.

Ratios mentioned herein are based on weight/weight, unless indicated otherwise. Similarly, all percentages are percentages by weight (w/w) unless otherwise indicated.

Numerical ranges expressed in the format “from x to y” are understood to include x and y.

When for a specific feature multiple preferred ranges are described in the format “from x to y”, it should be understood that all ranges combining the different endpoints are also contemplated. If for a particular component a range of 0% to y % or less than y % is recited, said ingredient may be absent.

The terms “a” and “an” and “the” and similar referents as used herein refer to both the singular and the plural, unless otherwise indicated herein or clearly contradicted by context.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Concentrations expressed by weight of dry matter as mentioned herein refer to the amount of dry ingredient that is present in a composition as a percentage of the total amount of dry matter that is contained in the same composition.

The term “barrel temperature” as used herein refer to an extruder's barrel temperature setting.

For the devices that are used in the present process, the residence time as referred to herein, is calculated from the throughput [kg/minute] and the internal volume [m³], assuming that the mass that is processed in the extruder has a density of 1300 kg/m³:

Residence time=Internal volume×Density/Throughput

The term “mechanical shear” as used herein refers to the application of shear strain by rotating elements, such as screws or stirrers.

The term “fat” as used herein refers to a glyceride component selected from triglycerides, diglycerides, monoglycerides, phosphoglycerides and combinations thereof.

The term “plant-based fiber” as used herein refers to dietary fiber that is naturally present in plants, and that may be water-soluble or water-insoluble. The content of plant-based fiber equals the total amount of of glucose, galactose, arabinose, xylose, mannose, rhamnose, fucose and galacturonic acid as determined upon Saeman hydrolysis, after removal of any starch and correcting for any free sugars present before Seaman hydrolysis.

### Proteinaceous Extrudate

The present process is particularly suited for producing meat analogues. Accordingly, in a preferred embodiment, no animal meat is employed in the present process. According to an even more preferred embodiment, the present process yields a vegan extrudate, meaning that no animal products (e.g. meat, eggs, dairy products) are employed in the process.

The proteinaceous extrudate that is produced by the present process preferably has a protein content of 19 to 45 wt. %, more preferably of 20 to 43 wt. % and most preferably of 21 to 40 wt. %.

The water content of the proteinaceous extrudate preferably is in the range of 53 to 65 wt. %, most preferably in the range of 55 to 62 wt. %.

The combination of protein and water preferably constitutes at least 74 wt. %, more preferably 75-96 wt. % of the proteinaceous extrudate.

Besides protein and water, the proteinaceous extrudate may suitably contain other components, such as dietary fibre, fat, sugars, vitamins and minerals.

### Proteinaceous Slurry

The proteinaceous slurry preferably comprises 19-41 wt. % of plant protein and 56-65 wt. % water. Most preferably, the proteinaceous slurry preferably comprises 20-38 wt. % of plant protein and 58-62 wt. % water.

The plant protein in the proteinaceous slurry is preferably selected legume protein, cereal protein, oilseed protein and combinations thereof.

Examples of legume proteins that may be used include soy protein, pea protein, lupin protein, faba bean protein, mung bean protein, lentil protein, chickpea and combinations thereof.

Preferably, the proteinaceous slurry contains at least 50 wt. % legume protein by weight of dry matter. More preferably, the proteinaceous slurry contains 53 to 90 wt. % legume protein by weight of dry matter. Most preferably, the proteinaceous slurry contains 60 to 75 wt. % legume protein by weight of dry matter.

According to a particularly preferred embodiment, at least 50 wt. %, more preferably at least 80 wt. % and most preferably at least 90 wt. % of the plant protein that is present in the proteinaceous slurry is soy protein.

The proteinaceous slurry preferably contains up to 30 wt. % of plant-based fiber by weight of dry matter, preferably 15 to 25 wt. % of plant-based fiber by weight of dry matter.

Examples of plant-based fibers that may suitably be present in the proteinaceous slurry include soy fiber, pea fiber, fava bean fiber, lupin fiber, oil seed fiber (such as sunflower seed fiber or cotton seed fiber, rapeseed fiber), fruit fiber (such as apple fiber), cereal fiber (such as oat fiber, maize fiber, rice fiber), bamboo fiber, potato fiber, inulin and combinations thereof.

The proteinaceous slurry may suitably be prepared by mixing aqueous liquid with one or more sources of plant protein. Examples of suitable sources of plant protein are protein concentrates, protein isolates and high protein flours. These one or more sources of protein preferably have a protein content of at least 50 wt. % by weight of dry matter, preferably a protein content of 55-90 wt. % by weight of dry matter.

Besides plant protein, the source of protein may suitably contain up to 30 wt. %, preferably 15-25 wt. % of plant-based fiber.

Preferably, the sources of plant protein employed in accordance with the invention have a water content of less than 15 wt. %, more preferably of less than 12 wt. %.

The proteinaceous slurry is preferably prepared by mixing a soy protein concentrate with water, said soy protein concentrate having a protein content of at least 60 wt. %, preferably having a protein content of 65-90 wt. %, most preferably of 67-73 wt. %, all based on dry weight, using a N-factor of 6.25 to calculate the protein content (DUMAS).

In another preferred embodiment, the proteinaceous slurry that is processed in an extruder in accordance with the present invention does not comprise gluten.

The proteinaceous slurry preferably comprises 0 to 5 wt. % of fat.

The combination of plant protein and water preferably constitutes at least 83 wt. %, more preferably 85 to 95 wt. % of the proteinaceous slurry.

Besides water and sources of plant protein, other ingredient may be introduced into the proteinaceous slurry. Examples of such ingredients include: sources of plant-based fibre, fat, vitamins, minerals, colouring, flavouring.

### Extruder

According to a particularly preferred embodiment, the extruder employed in the present process is a twin screw extruder.

The extruder that is employed in the present process preferably has a total screw length:screw diameter ratio of at least 20:1, more preferably it has a total screw length:screw diameter ratio in the range of 40:1 to 30:1.

In the present process, the proteinaceous slurry is preferably formed within the extruder. Preferably, this is done by introducing a dry mix comprising plant protein into the extruder and by injecting aqueous liquid downstream of the introduction of the dry mix.

The total residence time of the proteinaceous slurry in the extruder is preferably in the range of 1 to 10 minutes, more preferably in the range of 1.5 to 6 minutes and most preferably in the range of 2 to 4 minutes.

During processing of the proteinaceous slurry in the extruder, the temperature of the slurry preferably does not exceed 200° C., more preferably does not exceed 195° C. and most preferably does not exceed 190° C.

The extruder that is employed in the process according to the invention comprises three separate temperature controlled zones, i.e. a heating zone, a kneading zone and a pre-cooling zone. According to a particularly preferred embodiment, each of the aforementioned zones is formed by one or more temperature controlled extrusion barrels.

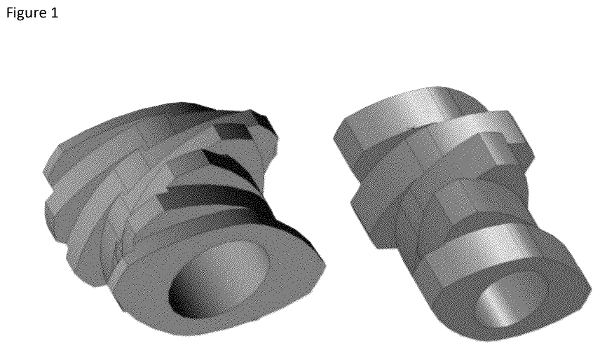

The screws of the extrusion barrels that are employed in the kneading step comprise one or more kneading blocks. An example of a suitable kneading block is shown in FIG. 1.

### Heating Step

The heating step is carried out in a sequence of one or more separately temperature controlled extrusion barrels. The barrel temperature of these one or more extrusion barrels preferably is at least 95° C., more preferably at least 98° C. and most preferably 100-170° C.

During the heating step, the proteinaceous slurry is preferably not subjected to kneading.

The screws of the one or more temperature extrusion barrels in which the heating step is carried out preferably do not comprise any kneading blocks.

The residence time of the proteinaceous slurry in the one or more temperature controlled extrusion barrels that are employed in the heating step preferably is in the range of 0.2 to 4 minutes, more preferably 0.3 to 2 minutes and most preferably 0.4-1.2 minutes.

### Kneading Step

The hot slurrys that is produced in the heating step is subsequently subjected to a kneading step. Preferably, the hot slurry is kneaded in a sequence of one or more kneading barrels having a barrel temperature of 160-195° C., more preferably having a barrel temperature of 170 to 190° C.

The residence time of the hot slurry in the one or more kneading barrels that are employed in the kneading step preferably is in the range of 0.3 to 5 minutes, more preferably 0.5 to 3 minutes and most preferably 0.6-1.8 minutes.

The screws of the one or more kneading barrels comprise one or more kneading blocks. Together, the one or more kneading blocks preferably cover 10-100%, more preferably 15-80% and most preferably 18-50% of the total screw length of the one or more kneading barrels.

### Pre-Cooling Step

The pre-texturized proteinaceous mass that is produced in the kneading step is subsequently subjected to a pre-cooling step. Preferably, this is achieved by transporting the pre-texturized proteinaceous mass through a sequence of one or more extrusion barrels having a barrel temperature of 80-120° C., more preferably a barrel temperature of 85-110° C. preferably from 80 to 130° C., preferably from 85° C. to 120° C., more preferably a barrel temperature of from 90 to 115° C.

The residence time of the pre-texturized proteinaceous mass in the one or more separately temperature controlled extrusion barrels that are employed in the pre-cooling step preferably is in the range of 0.2 to 4 minutes, more preferably 0.3 to 2 minutes and most preferably 0.4 to 1.2 minutes.

In a preferred embodiment, the barrel temperature of the sequence of one or more extrusion barrels that are employed in the pre-cooling step is at least 20° C. lower, preferably from 20° C. to 120° C., more preferably 30-80° C. lower than the barrel temperature of the sequence of one or more kneading barrels.

The pre-cooling step of the present process may optionally include kneading of the pre-texturized proteinaceous mass.

### Breaker Plate

In the present process a breaker plate is employed that separates the extruder from the cooling die. The breaker plate can be used to provide adequate back pressure and/or to impart high shear forces onto the texturized proteinaceous mass.

The breaker plate that is employed in the present process preferably comprises a plurality of orifices through which extrusion mass can leave the extruder. These orifices may provided in various forms, e.g. circular openings or slits.

Together, the orifices in the breaker plate preferably occupy from 10 to 50%, more preferably from 12 to 40% and most preferably from 15 to 35% of the surface area of the breaker plate that faces the extruder and that comes into contact with extrusion mass.

The inventors have observed that the texture of the fibrous proteinaceous extrudate that is obtained by the present process is particularly preferred by consumers if it is ensured that the texturized proteinaceous mass has a temperature of 110-140° C., more preferably a temperature of 115-138° C., and most preferably of 120-135° C. when it passes through the breaker plate.

The back pressure at the breaker plate preferably is in the range of 15 to 50 bar, more preferably in the range of 17 to 40 bar and most preferably in the range of 18 to 32 bar.

### Cooling Die

The cooling die that is employed in the present process is preferably cooled by a liquid cooling medium. The liquid cooling medium preferably has a temperature in the range of 50 to 80° C., more preferably a temperature in the range of 55 to 75° C.

The texturized proteinaceous mass that is produced in the pre-cooling step is preferably cooled in the cooling die to decrease the average temperature of the texturized proteinaceous mass by at least 10° C., more preferably by at least 15° C. and most preferably by 18-33° C. Here the average temperature refers to the average temperature of the segment of texturized proteinaceous mass that has travelled the same distance through the cooling die.

The texturized proteinaceous mass is preferably cooled in the cooling die at an average cooling rate of 0.2 to 3° C. per minute, more preferably at an average cooling rate of 0.3 to 2° C. per minute.

Preferably, no mechanical shear is applied to the texturized proteinaceous mass in the cooling die.

The residence time in the cooling die preferably is in the range of 0.2 to 5 minutes, more preferably 0.3 to 3 minutes and most preferably in the range of 0.4-1.5 minutes.

The structured proteinaceous mass is preferably expelled from the cooling die at a flow rate of 50 to 500 g/h/mm², more preferably at a flow rate of 80 to 400 g/h/mm², most preferably at a flow rate of 120 to 320 g/h/mm².

The process of the present invention is preferably operated at a throughput of at least 50 kg/hr, more preferably of at least 80 kg/hr and most preferably of 100 to 3,000 kg/hr.

In a preferred embodiment of the present process, the aqueous proteinaceous slurry that is provided in step a) has a water content of 56 to 65% water and the texturized proteinaceous mass has a temperature of 120-135° C. when it passes through the breaker plate

According to particularly preferred embodiment, the present process comprises the steps of:
a) providing an aqueous proteinaceous slurry said slurry comprising 19-41 wt. % of plant protein and 56-65 wt % of water, wherein at least 80 wt. % of the plant protein is soy protein;
b) processing said aqueous proteinaceous slurry in an extruder, said processing comprising the following steps:
   a heating step comprising transporting the aqueous proteinaceous slurry through a sequence of one or more extrusion barrels having a barrel temperature of 100-170° C., to produce a hot slurry;
   a kneading step comprising transporting the hot slurry through a sequence of one or more kneading barrels having a barrel temperature of 160-195° C., the hot slurry being kneaded in the one or more kneading barrels to produce a pre-texturized proteinaceous mass;
   a pre-cooling step comprising transporting the pre-texturized proteinaceous mass through a sequence of one or more extrusion barrels having a barrel temperature of 80-120° C., to produce a texturized proteinaceous mass;
c) passing the texturized proteinaceous mass through a breaker plate from the extruder into a cooling die that is cooled by liquid cooling medium having a temperature in the range of 50-80° C., in which the texturized proteinaceous mass is given a residence time of 0.3-3 minutes to produce a structured proteinaceous mass; and
d) expelling the structured proteinaceous mass from the cooling die at a flow rate of 80 to 400 g/h/mm² to produce a fibrous proteinaceous extrudate.

The fibrous proteinaceous extrudate preferably has a core temperature of 102-120° C., more preferably a core temperature of 104-115° C., immediately after expulsion. The core temperature is measured within 10 seconds after leaving the die with a temperature sensor. The core temperature may suitably be measured by cutting through the expelled extrudate and inserting a temperature sensor into the core of the extrudate.

### Extrudate and Uses Thereof

Another aspect of the invention relates to a fibrous proteinaceous extrudate that is obtainable by the process as specified herein before. Preferably, said fibrous proteinaceous extrudate that is obtained by the process as specified herein before

The invention also provides a process of preparing marinated proteinaceous pieces, wherein the aforementioned fibrous proteinaceous extrudate is divided into proteinaceous pieces and wherein the proteinaceous pieces are marinated with a marination liquid comprising one or more taste contributing ingredients selected from spices, herbs, flavouring and combinations thereof. In a preferred embodiment, the proteinaceous pieces are blanched before marination.

In a preferred embodiment, the marination liquid comprises pieces of plant material selected from herbs, spices and combinations thereof.

The invention also pertains to marinated proteinaceous pieces that are obtainable, more preferably that are obtained by the aforementioned process of preparing marinated proteinaceous pieces.

The invention is further illustrated by the following non-limiting examples.

### EXAMPLES

### Example 1

Proteinaceous extrudates were produced from a proteinaceous slurry that had been prepared in accordance with the recipe that is shown in Table 1.

TABLE 1

| | Wt. % |
|---|---|
| Alpha ® 8 ¹ | 20 |
| Unico HB ² | 20 |
| Water | 60 |

¹ Soy protein concentrate, ex Solae (US/NL) (protein content 67 wt. %, assuming a N-factor of 6.25)
² Soy protein concentrate, ex Vitablend, the Netherlands (protein content 70 wt. %, assuming a N-factor of 6.25)

The extrudates were produced using a co-rotating, intermeshing twin-screw extruder (DNDL44, ex Buhler, Switzerland), with an L/D ratio of 32. The screw configuration contained a combination of kneading, mixing, forward and reverse elements. The screw diameter was 44 mm. The extruder comprised 8 equally dimensioned barrels, which form 4 different successive zones:
Mixing Zone (barrel 1)
Heating Zone (barrels 2 and 3)
Kneading Zone (barrels 4, 5 and 6)
Pre-cooling Zone (barrels 7 and 8)

The barrels of the extrusion barrels employed in the heating, kneading and-precooling zones were heated to different pre-set temperatures using hot water. The extruder was separated from a cooling die by a breaker plate with a central slit with a width of 30 mm and a height of 3 mm. The cooling die employed had a length of 120 cm and was cooled using water.

The operating conditions of the extruder and the cooling die are summarised in Table

TABLE 2

| | | |
|---|---|---|
| Heating Zone | Barrel temperature of barrels 2 and 3 (° C.) | 140 |
| Heating Zone | Residence time in barrels 2 and 3 (min) | 0.6 |
| Kneading Zone | Barrel temperature of barrels 4, 5 and 6 (° C.) | 180 |
| Kneading Zone | Residence time in barrels 4, 5 and 6 (min) | 0.9 |
| Pre-cooling | Barrel temperature of barrels 7, 8 (° C.) | 100 |
| Zone | | |
| Pre-cooling | Residence time in barrels 7 and 8 (min) | 0.6 |
| Zone | | |
| | Temperature of cooling water of cooling | 75 |
| | die (° C.) | |
| | Residence time in cooling die (minutes) | 0.7 |
| | Cooling rate in cooling die (° C./s) | 0.5 |
| | Screw speed (rpm) | 165 |
| | Throughput (kg/hr) | 57.5 |
| | texturized proteinaceous mass temperature | 126 |
| | when passing the Breaker plate (° C.) | |
| | Pressure at break plate (bar) | 19 |

The extrudate was blast frozen directly upon production, stored frozen (−20° C.) and thawed for 24 hours. Once thawed, the extrudates were cut into pieces having an approximate length between 4-5 cm. The pieces were blanched for 5 min and then separated with a strainer. Subsequently, the pieces were marinated. The marinated pieces were transferred into zip-lock bags and frozen at −20° C. One day prior to the sensory evaluation, the zip-lock bags were transferred to the fridge to defrost.

### Example 2

Proteinaceous extrudates were produced from a proteinaceous slurry that had been prepared in accordance with the recipe that is shown in Table 1 whereby the barrel temperature in the heating step, kneading step, and precooling was set at respectively 140° C., 190° C. and 90° C. The temperature of the texturized proteinaceous mass had a temperature of 120° C. when passing through the breaker plate.

### Example 3

Proteinaceous extrudates were produced from a proteinaceous slurry that had been prepared in accordance with the recipe that is shown in Table 1 whereby the barrel temperature in the heating step, kneading step, and precooling was set at respectively 140° C., 180° C. and 105° C. The temperature of the texturized proteinaceous mass had a temperature of 134° C. when passing through the breaker plate.

### Method of Measuring Mouthfeel Elasticity and Toughness

The marinated pieces were evaluated by a panel 10 highly trained assessors selected from top 10% of population after screening on sensory abilities and sensitivities using defined selection criteria (ISO 8586). The panellists were trained in 6 sessions of 2.5 hrs. The marinated pieces were stored at 5° C. Sunflower oil (28 g) was heated in a non-stick frying pan on an electric stove at power 9. The marinated pieces (160 g) were added to the non-stick frying pan and cooked for 5 mins on one side, turned over and cooked for 1 min on the opposite side resulting in a chunk having a darker side and opposing lighter side.

The cooked marinated pieces were covered with foil and stored in an oven pre-heated to 60° C. prior to testing. The cooked marinated pieces were stored for a maximum of 15 mins. Three-digit coded chicken pieces (3 pieces per panel member) were served on a porcelain plate with knife and fork (blind testing). Products were tested under white light. Palate cleansers were made available (water and crackers).

Experienced panellists divided the marinated pieces into 4 equal parts and placed one piece in the mouth with the light-coloured side facing the roof of the mouth and gave a degree of elasticity and toughness score based on the first chew.

Sensory evaluation of the marinated pieces of examples 1-3 by the expert panel showed that these had a very pleasant texture that was very similar to that of chicken meat, especially in terms of “elasticity” and “toughness”.

### Comparative Example A

Protein extrudates were produced whereby no pre-cooling of at least 15° C. was applied in the pre-cooling zone. The barrel temperatures were set at 140° C. (heating zone), 151° C. (kneading zone), 140° C. (pre-cooling zone) respectively and the texturized proteinaceous mass had a temperature of 149° C. when passing through the breaker plate. The resultant product was too tough and showed less resemblance to chicken meat (less fibrous, more sponge-like).

1. A process for producing a fibrous proteinaceous extrudate, said process comprising the steps of:
a) providing an aqueous proteinaceous slurry, said slurry comprising at least 52 wt % of water;
b) processing said aqueous proteinaceous slurry in an extruder, said processing comprising the following steps:
a heating step comprising transporting the aqueous proteinaceous slurry through a sequence of one or more extrusion barrels having a barrel temperature of at least 90° C., to produce a hot slurry;
a kneading step comprising transporting the hot slurry through a sequence of one or more kneading barrels having a barrel temperature of 151-200° C., the hot slurry being kneaded in the one or more kneading barrels to produce a pre-texturized proteinaceous mass;
a pre-cooling step comprising transporting the pre-texturized proteinaceous mass through a sequence of one or more extrusion barrels having a barrel temperature that is at least 15° C. lower than the barrel temperature of the one or more kneading barrels, to produce a texturized proteinaceous mass;
c) passing the texturized proteinaceous mass through a breaker plate from the extruder into a cooling die in which the texturized proteinaceous mass is given a residence time of at least 10 seconds to produce a structured proteinaceous mass; and
d) expelling the structured proteinaceous mass from the cooling die at a flow rate of 30 to 1000 g/h/mm² to produce a fibrous proteinaceous extrudate, whereby the term “barrel temperature” refers to the barrel temperature setting.

2. The process according to claim 1, wherein the aqueous proteinaceous slurry that is provided in step a) comprises 19-41 wt. % of plant protein and 56-65 wt. % water.

3. The process according to claim 2, wherein the process is operated at a throughput of at least 50 kg/hr.

4. The process according to claim 2, wherein at least 50 wt. % of the plant protein is soy protein.

5. The process according to claim 1, wherein the aqueous proteinaceous slurry contains at least 50 wt. % legume protein by weight of dry matter.

6. The process according to claim 1, wherein the aqueous proteinaceous slurry comprises 0-5 wt. % of fat.

7. The process according to claim 1, wherein the aqueous proteinaceous slurry is provided by introducing a dry mix comprising plant protein into the extruder and by injecting aqueous liquid downstream of the introduction of the dry mix.

8. The process according to claim 1, wherein the residence time of the proteinaceous mass in the sequence of one or more kneading barrels that are employed in the kneading step is in the range of 0.3 to 5 minutes.

9. The process according to claim 1, wherein the barrel temperature of the one or more extrusion barrels employed in the pre-cooling step is from 80° C. to 130° C., more preferably of from 85 to 110° C.

10. The process according to claim 1, wherein the texturized proteinaceous mass is cooled in the cooling die to decrease the average temperature of the texturized proteinaceous mass by at least 15° C.

11. The process according to claim 1, wherein the texturized proteinaceous mass has a temperature of 120 to 135° C. when passing through the breaker plate, and wherein the back pressure at the breaker plate is in the range of 15 to 50 bar.

12. The process according to claim 1, wherein the fibrous proteinaceous extrudate has a core temperature of more than 100° C. immediately after expulsion.

13. Fibrous proteinaceous extrudate prepared by the process according to claim.

14. The process according to claim 1, and further comprising: A process of preparing marinated proteinaceous pieces from the fibrous proteinaceous extrudate by dividing the fibrous proteinaceous extrudate into proteinaceous pieces and marinating with a marination liquid comprising one or more taste contributing ingredients selected from spices, herbs, flavouring and combinations thereof.

15. Marinated proteinaceous pieces obtainable by the process according to claim 14.
